(19) United States
(12) Patent Application Publication
(10) Pub. No.: US 2011/0003048 A1
(43) Pub. Date: Jan. 6, 2011

(54) ELECTRIC RICE COOKER AND METHOD OF COOKING RICE

(76) Inventors: Naoki Sugimoto, Tottori (JP); Akio Hokimoto, Tottori (JP); Tetsuya Matsuoka, Tottori (JP); Naomi Shimomura, Tottori (JP); Daisuke Okamoto, Tottori (JP)

Correspondence Address: MCDERMOTT WILL & EMERY LLP, 600 13TH STREET, N.W., WASHINGTON, DC, 20005-3096, US

(21) Appl. No.: 12/866,705

(22) PCT Filed: Dec. 17, 2008
(86) PCT No.: PCT/JP2008/072933

§ 371 Date: Aug. 6, 2010

(30) Foreign Application Priority Data
Feb. 7, 2008 (JP) 2008-027224
Apr. 14, 2008 (JP) 2008-104832

(51) Int. Cl. A47J 27/62; A47J 27/086; A23L 1/01

(52) U.S. Cl. 426/509; 99/331; 99/342; 99/468

(57) ABSTRACT

An electric rice cooker capable of increasing the water content of rice by a simple structure. The electric rice cooker (1) has a pot (10) in which food substances to be cooked including water and rice are contained, heating device (5, 6, 19) for heating the food substances to be cooked in the pot, a lid (11) for closing the opening of the pot, and a controller (9) for performing rice cooking steps including a water absorption step for allowing the rice to absorb the water by controlling the heating devices. The controller (9) raises the internal pressure of the pot (10) to 1.05-1.18 atm in the water absorbing step to allow the rice to absorb the water.

### TECHNICAL FIELD

The present invention relates to an electric rice cooker and a method of cooking rice. Specifically, the present invention relates to an electric rice cooker and a method of cooking rice in which rice is allowed to absorb sufficient water to be cooked.

### BACKGROUND ART

### Background Art 1

It is known that the water content absorbed by rice does not increase above a certain value even if rice is immersed in room-temperature water for a long time in a water absorption step of rice cooking steps. One of the factors is that rice has a structure such that starch inside thereof is surrounded by a hard cell and hence water is hard to be absorbed. When cooking is performed with the water content remained low, the cooked rice may be hard, have no stickiness, and be dry, possibly with its center un-cooked. Thus, in the water absorption step, the room-temperature water is normally heated to a predetermined temperature to allow the water content of rice to be increased by the heated water. Inconveniently, however, when the temperature of the heated water is a predetermined value or above, for example 60° C. or above, rice starch starts to gelatinize and the surface of the rice gelatinizes first. This adversely makes it difficult for water to permeate into the rice. Thus, conventional rice cookers are designed ingeniously such that, in the water absorption step, the water content is increased while starch gelatinization is prevented (for example, see Patent Documents 1 to 3 listed below).

For example, a rice cooker disclosed in Patent Document 1 listed below is so designed that water absorption speed is increased by provision of steam generating means. In this rice cooker, steam is fed from the steam generating means into a pot in the water absorption step—namely an immersing step—for allowing rice to absorb water, and the temperature of water in the initial stage of cooking rice is increased, in a short time, to a temperature at which no gelatinization occurs, so as to speed up a water-temperature rise time and thereby increase the water absorption speed. Moreover, a rice cooker disclosed in Patent Document 2 is so designed that the water content is increased by provision of a pre-immersing step before a normal immersing step. In the pre-immersing step, by use of steam generating means for generating steam heated to 100° C. or above, the heated steam is injected into a pot before a normal immersing step starts so as to increase the water content, and after completion of the pre-immersion, the normal immersing step is performed. Furthermore, in a rice cooker disclosed in Patent Document 3 listed below, before a normal immersing step, a steam processing step is provided for allowing water to be absorbed with the pressure inside a pot being higher than atmospheric pressure.

Next, with reference to FIG. 10, the rice cooker disclosed in Patent Document 3 will be described in more detail. FIG. 10 is a sectional view of the rice cooker disclosed in Patent Document 3 listed below.

The rice cooker 40 is provided with a pot 41 for accommodating rice; steam generating means 43 for generating steam by vaporizing water; and pressure adjusting means 44 for adjusting the pressure inside the pot 41. In the rice cooker 40, before proceeding to a normal immersing step, a steam processing step is executed. Specifically, first, rice and a small amount of water for steam generation are put into the pot 41, and inside the pot 41 is heated by pot heating means 42, so as to vaporize water to generate steam. Here, a steam hole 44a is closed by the pressure adjusting means 44 to prevent steam from being released from the pot 41 so as to make the pressure inside the pot 41 higher than atmospheric pressure. Then, since the internal pressure of the pot 41 is higher than atmospheric pressure, high-temperature steam at 100° C. or above is cooled rapidly at the surface of rice having a temperature lower than 100° C. and condenses, and dew is deposited on the surface of rice. By being heated by heat of the steam and heat of liquefaction generated when steam liquefies, the surface of the rice then has a condition such that water is easily absorbed, and the dew deposited on the surface of the rice is absorbed. In addition, since the pressure inside the pot 41 is raised, high pressure is applied to water and to rice. This pressure makes it easier for the water to pass through rice cell walls, allowing even more water to be absorbed by starch. Thereafter, the normal immersing step is performed. Having undergone the steam processing step, the temperature of the surface of the rice is high; thus, by being rapidly cooled by water fed in the normal immersing step, the surface of the rice has such a condition that water is more easily absorbed. Accordingly, in the normal immersing step, a larger amount of water is absorbed as compared with a case where no steam processing step is performed.

### Background Art 2

In recent years, an electric rice cooker (hereinafter simply referred to as a “rice cooker”) is provided with a microcomputer and, by the microcomputer, rice cooking control is executed sequentially. The rice cooking control includes: a water absorption step for allowing food-substances-to-be-cooked inside a pot to absorb a predetermined amount of water; a start-up heating step for raising temperature to heat the water-absorbed food-substances-to-be-cooked until they boil; a boiling keeping step for keeping the food-substances-to-be-cooked in a boiling state; a steaming step for steaming the food-substances-to-be-cooked; and a warming step for warming at a predetermined temperature. The rice cooking control is performed by judging the quantity of rice-to-be-cooked inside the pot.

Of methods of judging the quantity of rice-to-be-cooked, one is to directly measure the weight of food-substances-to-be-cooked. When this method is adopted, however, a weight scale or the like is needed. Thus, a temperature sensor is normally provided at the bottom of a pot. By the temperature sensor, the temperature at the bottom of the pot is detected and, from the value of the detected temperature, the quantity of rice-to-be-cooked is judged. The judgment of the quantity of rice-to-be-cooked is normally performed in the start-up heating step after the water absorption step. Performing this judgment in the start-up heating step has advantages including enabling judgment of the quantity of rice-to-be-cooked even in a case of executing menus, such as a quick cooking menu, where no water absorption step is undergone, and facilitating judgment of the quantity of rice-to-be-cooked since the temperature gradient is high in the start-up heating step. However, it is impossible to control the output of a heating device according to the quantity of rice-to-be-cooked from an early stage of the start-up heating step. Thus, performing judgment in the start-up heating step adversely affects the rice cooking performance, leading to problems such as being difficult particularly in adjustment of cooking rice to be harder or softer.

Thus, recently, methods have been proposed of performing judgment of the quantity of rice-to-be-cooked in a water absorption step before proceeding to a start-up heating step. However, judgment performed in the water absorption step is likely to be affected by the ambient temperature at the time of cooking rice, particularly the temperature of water used for cooking rice, the so-called initial water temperature. This leads to a manifestation of problems such as precise judgment being impossible unless the initial water temperature is taken into consideration.

Examples of methods for solving the problems are as follows. Patent Document 4 listed below discloses a rice cooker so designed that the temperature range of the initial water temperature is previously divided into a plurality of temperature regions, and, based on a plurality of step threshold values previously set for each of the divided temperature regions, the quantity of rice-to-be-cooked is judged. Moreover, Patent Document 5 listed below discloses a rice cooker so designed that, in a water absorption step, judgment of the quantity of rice-to-be-cooked is performed while the detection temperature of an inner kettle is gradually raised, and the amount of heating thereafter is adjusted according to the results of judging the quantity of rice-to-be-cooked. Furthermore, Patent Document 6 listed below discloses a rice cooker so designed that, when the initial water temperature at the start of cooking rice is at or higher than a predetermined temperature, either, without using judgment data of quantity-of-rice-to-be-cooked judging means obtained during a water absorption step, heating output at switching of cooking-up steps is set based on intermediate alternate data or on judgment data of the quantity-of-rice-to-be-cooked judging means newly obtained during a temperature raising step; or water absorption heating is stopped to let the temperature of water drop or be stabilized, so as to permit proper judgment of the quantity of rice-to-be-cooked to be newly performed. Furthermore, Patent Document 7 listed below discloses a rice cooker so designed that judgment of the quantity of rice-to-be-cooked is performed in both a water absorption step and a temperature raising step (corresponding to the start-up heating step mentioned above).

Patent Document 1: JP-A-2003-144308 (paragraphs from [0021] to [0023], FIG. 1)
Patent Document 2: JP-A-2005-168546 (paragraphs from [0025] to [0033], FIG. 2)
Patent Document 3: JP-A-2007-151648 (paragraphs from [0041] to [0046], FIG. 1)
Patent Document 4: JP-A-2005-58654 (paragraph [0043], FIG. 3)
Patent Document 5: JP-A-2004-275226 (paragraphs from [0044] to [0046], FIG. 7)
Patent Document 6: JP-A-2004-201804 (paragraph [0038], FIG. 4)
Patent Document 7: JP-A-2005-65928 (paragraphs [0039] and [0040], FIGS. 4 and 5)

### DISCLOSURE OF THE INVENTION

### Problems to be Solved by the Invention

(Problems of Background Art 1)

According to Patent Documents 1 to 3 listed above, the rice cookers have respective specific designs, and these designs permit increased water content and hence tasty rice to be cooked to completion. These rice cookers, however, require steam generating means etc. as a new component and also require a special pre-immersing step or a special steam processing step in addition to the normal immersing (water absorption) step, thus leading to complicated design and control of the rice cookers. For example, with the rice cooker disclosed in Patent Document 1 listed above, even though the water absorption speed of rice is increased by increasing the water temperature in a short period of time to a temperature where no gelatinization occurs in an early stage of cooking rice, water absorption into rice during the immersing step is not sufficient. Moreover, in the rice cooker disclosed in Patent Document 2 listed above, when steam is fed, the steam is cooled rapidly at the surface of rice and condenses thereon, and dew is deposited on the surface of rice. Then, by being heated by the amount of heat etc. of the steam, the surface of rice has a condition which easily absorbs water, allowing the dew deposited on the surface of rice to be absorbed even more. However, although steam condenses on the surface of rice so that dew is deposited thereon, no water is supplied to starch in an inner part of rice, making it difficult to increase the water content of the inner part of rice. Thus, duration for allowing rice to absorb water is required in the following rice cooking process, which makes it difficult to shorten the duration of cooking rice as a result. Furthermore, with the rice cooker disclosed in Patent Document 3 listed above, when proceeding to the water absorption step after the completion of the steam processing step, water feeding work is required where a predetermined amount of water needs to be fed. This work involves opening a lid of the rice cooker after the completion of the steam processing step, feeding water while checking the amount of water corresponding to the quantity of rice put into the pot, and thereafter, closing the lid to start a normal rice cooking step. This work can not be automated and is performed manually, and thus is troublesome. Moreover, with rice cookers of this type, since a pot is heated from the bottom of the pot and from a side wall face thereof, water and rice close to the bottom of the pot and the side wall face thereof are heated at a predetermined temperature in a water absorption step. However, rice and water in a middle part of the pot has a lower temperature than a part close to the bottom of the pot and the side wall face thereof, and thus variation in water absorption, so-called uneven water absorption, may result between those parts.

The present inventor et al. have been engaged in development and commercialization of rice cookers. In recent years, in a pressure rice cooker in which rice is cooked with the pressure inside a pot being raised to or higher than atmospheric pressure, the present inventor et al. have developed and commercialized a rice cooker in which rice is cooked by causing a so-called bumping phenomenon—a phenomenon where the pressure inside the pot is decreased from high pressure to around atmospheric pressure by opening a pressure valve temporarily in a boiling keeping step after a water absorption step so as to agitate the rice vigorously inside the pot. The present inventor et al. have already acquired several patents on inventions relating to those technologies (for example, see Japanese Patent No. 3851293). For example, a pressure rice cooker disclosed in Japanese Patent No. 3851293 is so designed that, in a boiling keeping step of rice cooking steps, by forcibly opening a pressure valve and immediately decreasing the pressure inside a pot during boiling so as to be around atmospheric pressure, a bumping phenomenon is caused inside the pot so as to agitate rice grains to cook them.

In this rice cooker, however, in the water absorption step, inside the pot is heated while a pressure valve being opened, i.e., with no pressure applied inside the pot. Incidentally, it has been found that, in the water absorption step, when the pressure valve is closed and heating is performed at a predetermined temperature to raise the pressure inside the pot to a predetermined pressure, the water content of rice increases. Since the pressure rice cooker has the pressure inside the pot increased in the boiling keeping step, the present invention has been devised with consideration given to pressure raising being possible in the water absorption step by utilizing this mechanism as is and by simply changing a control method of a controller in existing rice cookers.

Thus, the present invention has been devised to solve the problems of the above-described conventional art (Background Art 1), and has been devised under the above development background. A principal object of the invention is to provide an electric rice cooker and a method of cooking rice capable of increasing the water content of rice by a simple design.

Another object of the invention is to provide an electric rice cooker and a method of cooking rice capable of increasing the water content of rice and reducing uneven water absorption in a water absorption step so that tasty rice is cooked to completion, by simply changing the control method without changing the structure of the conventional rice cookers and without newly providing another rice cooking step etc.

(Problems of Background Art 2)

Rice cooking control using a microcomputer is performed by judging the quantity of rice-to-be-cooked inside a pot as described above. The judgment of the quantity of rice-to-be-cooked has been shifted from a method where the weight of an article-to-be-cooked is directly measured, to judgment in a start-up heating step in cooking steps, and further to judgment in a water absorption step. However, even with the judgment in the water absorption step, judgment is performed by temperature detection, and thus it is easily affected by the environment—particularly the initial water temperature—during cooking rice, making accurate judgment of the quantity of rice-to-be-cooked difficult. Thus, the rice cookers disclosed in Patent Documents 4 to 6 listed above are each designed so as to be less susceptible to the initial temperature. However, there is still a room for improvement, and, as a result, as with the rice cooker disclosed in Patent Document 7 listed above, judgment has to be performed in both the start-up heating step and the water absorption step to use advantages of judgment accuracy in the both steps depending on the conditions of cooking menus etc. Accordingly, in a case where judgment of the quantity of rice-to-be-cooked is performed by temperature detection, judgment has to be performed in both the start-up heating step and the water absorption step as described above.

As described above, the present inventor et al. have been engaged in development and commercialization of rice cookers. In recent years, in a pressure rice cooker in which rice is cooked with the pressure inside a pot being raised to or higher than atmospheric pressure, the present inventor et al. have developed and commercialized a rice cooker in which rice is cooked by causing a so-called bumping phenomenon—a phenomenon where the pressure inside the pot is decreased from high pressure to around atmospheric pressure by opening a pressure valve temporarily in a boiling keeping step after a water absorption step so as to agitate the rice vigorously inside the pot. The present inventor et al. have already acquired several patents on inventions relating to those technologies (for example, see Japanese Patent No. 3851293).

However, in this rice cooker, inside a pot is heated in the water absorption step with a pressure valve opened, i.e., with no pressure applied inside the pot. However, it has been found that, in the water absorption step, when the pressure valve is closed and heating is performed at a predetermined temperature to raise the pressure inside the pot, the water content of rice increases. Furthermore, the water content increases to a predetermined value—a high value—, and it has been found that the pressure applied saturates at the value of the high water content, and the saturated pressure value relates closely to the quantity of rice-to-be-cooked, specifically the pressure value and the quantity of rice-to-be-cooked are in a one-to-one relationship. Thus, the present invention has been devised with consideration given to the fact that detection of the pressure inside the pot in the water absorption step permits judgment of the quantity of rice-to-be-cooked, and moreover, permits the problem of judgment based on temperature as in the conventional technology to be overcome.

Thus, the present invention has been devised to solve the problems of the above-described conventional art (Background Art 2), and has been devised under the above development background. Another object of the invention is to provide an electric rice cooker and a method of cooking rice capable of judging, in a water absorption step, the quantity of rice-to-be-cooked without being affected by the ambient temperature.

Yet another object of the invention is to provide an electric rice cooker and a method of cooking rice capable of judging the quantity of rice-to-be-cooked without being affected by the ambient temperature, by simply changing a control method without changing the structure of the conventional rice cookers and without newly providing another rice cooking step etc.

Still another object of the invention is to provide an electric rice cooker and a method of cooking rice capable of achieving the above objects by increasing the water content of rice.

### Means for Solving the Problem

To achieve the above object, according to claim 1, an electric rice cooker comprises: a pot for accommodating food-substances-to-be-cooked including water and rice; a heating device for heating food-substances-to-be-cooked inside the pot; a lid body for closing an opening of the pot; and a controller for executing rice cooking steps including a water absorption step for allowing rice to absorb water by controlling the heating device. Here, the controller raises pressure inside the pot to a predetermined value in the water absorption step to allow rice to absorb water.

According to the invention of claim 2, in the electric rice cooker of claim 1, the controller raises and controls pressure inside the pot to be within a range from 1.05 to 1.18 atmospheres in the water absorption step.

According to the invention of claim 3, in the electric rice cooker of claim 1, pressure inside the pot is changed according to the quantity of rice-to-be-cooked inside the pot.

According to the invention of claim 4, the electric rice cooker of claim 1 further comprises: a pressure detector for detecting pressure inside the pot; and a quantity-of-rice-to-be-cooked judging portion for receiving a detected value of the pressure detector and judging the quantity of rice-to-be-cooked inside the pot. Here, in the water absorption step, after the pot is hermetically sealed, the controller raises temperature inside the pot to a predetermined temperature with the heating device, detects a pressure value inside the pot with the pressure detector, and feeds the detected value to the quantity-of-rice-to-be-cooked judging portion to judge the quantity of rice-to-be-cooked inside the pot.

According to the invention of claim 5, in the electric rice cooker of claim 4, the controller includes a memory portion. Here, the memory portion stores a target pressure inside the pot in the water absorption step and quantity-of-rice-to-be-cooked data corresponding to the target pressure. The quantity-of-rice-to-be-cooked judging portion checks the detected value detected by the pressure detector against the quantity-of-rice-to-be-cooked data stored in the memory portion to judge the quantity of rice-to-be-cooked inside the pot.

According to the invention of claim 6, the electric rice cooker of claim 4 further comprises a rice cooker body in which the pot is placed and the heating device is provided. Here, the pressure detector includes a pressure sensor for converting pressure into an electrical signal, and the pressure sensor is provided in the lid body or in the rice cooker body.

According to the invention of claim 7, in the electric rice cooker of claim 4, the rice cooking steps further include: a start-up heating step for raising temperature to heat food-substances-to-be-cooked that have absorbed water in the water absorption step until the food-substances-to-be-cooked boil; and a boiling keeping step for keeping food-substances-to-be-cooked in a boiling state. Here, the controller controls the heating amount of the heating device according to the quantity of rice-to-be-cooked inside the pot such that a first duration required for the start-up heating step is a predetermined duration, and that the first duration is in a constant relationship with a second duration required for the boiling keeping step, with any quantity of rice-to-be-cooked inside the pot.

According to the invention of claim 8, in the electric rice cooker of claim 7, the constant relationship is a relationship such that the first duration and the second duration are substantially equal.

According to the invention of claim 9, in the electric rice cooker of claim 1, the lid body is provided with a steam release hole for releasing steam inside the pot to the outside, and a valve opening/closing mechanism for closing or opening the steam release hole. Here, in the water absorption step, the controller operates the heating device and closes the steam release hole by the valve opening/closing mechanism to raise pressure inside the pot.

According to the invention of claim 10, in the electric rice cooker of claim 9, the steam release hole is shared as part of a pressure valve, and the valve opening/closing mechanism is shared as a pressure-valve opening mechanism for forcibly placing the pressure valve into an open state. Here, the controller performs rice cooking control with the pressure inside the pot raised to or above atmospheric pressure in the boiling keeping step of the rice cooking steps.

According to the invention of claim 11, in the electric rice cooker of claim 1, the heating device includes: a bottom heater for heating a bottom part of the pot; a side heater for heating a side part thereof; and an upper heater provided in the lid body for heating from above. Here, the controller controls the heating amount of at least the bottom heater in the water absorption step.

According to claim 12, a method of cooking rice comprises rice cooking steps including a water absorption step in which a predetermined amount of food-substances-to-be-cooked including rice and water is accommodated in a container for allowing rice to absorb water. Here, the internal pressure of the container is raised to a predetermined value in the water absorption step to allow rice to absorb water.

According to the invention of claim 13, in the method of cooking rice of claim 12, in the water absorption step, after the container is hermetically sealed, the temperature inside the container is raised to a predetermined temperature, whereupon the pressure inside the container is detected, and, based on a value of the detected pressure, the quantity of rice-to-be-cooked inside the container is judged.

According to the invention of claim 14, in the method of cooking rice of claim 13, quantity-of-rice-to-be-cooked data corresponding to the pressure value inside the container is previously set, and, with the detected pressure value checked against the quantity-of-rice-to-be-cooked data, the quantity of rice-to-be-cooked is judged.

According to the invention of claim 15, in the method of cooking rice of claim 13, the rice cooking steps further include: a start-up heating step for raising temperature to heat food-substances-to-be-cooked that have absorbed water in the water absorption step until the food-substances-to-be-cooked boil; and a boiling keeping step for keeping food-substances-to-be-cooked in a boiling state. Here, rice cooking is performed while the heating amount is controlled according to the quantity of rice-to-be-cooked inside the pot such that a first duration required for the start-up heating step is a predetermined duration, and that the first duration is in a constant relationship with a second duration required for the boiling keeping step, with any quantity of rice-to-be-cooked inside the container.

### ADVANTAGES OF THE INVENTION

With the design described above, the present invention achieves excellent benefits described below. Specifically, according to the invention of claim 1, by raising the pressure inside the pot to a predetermined value in the water absorption step, rice absorbs water efficiently and the water content increases. That is, by raising the pressure inside the pot, pressure is applied also to water and to rice, and this pressure makes it easier for water to pass through rice cell walls, allowing even more water to be absorbed by rice starch. The pressure applied to rice causes a tiny crack to develop in rice. Through the crack, water permeates into rice and passes through a gap between the rice cell walls to be fed to starch in a middle part of rice, thus increasing the water content. Furthermore, variation in water absorption inside the pot, i.e., so-called uneven water absorption is reduced.

According to the invention of claim 2, since the pressure inside the pot is set to be within the range from 1.05 to 1.18 atmospheres, it is possible to allow rice to absorb sufficient water effectively and efficiently without gelatinization of the surface of rice and without uneven water absorption. Note that the pressure range is confirmed by experiments.

According to the invention of claim 3, by changing the pressure inside the pot according to the quantity of rice-to-be-cooked, rice is allowed to absorb sufficient water effectively and efficiently.

According to the invention of claim 4, it is possible to precisely judge the quantity of rice-to-be-cooked inside the pot without being affected by the initial water temperature as in the conventional technology. Thus, in the following rice cooking steps, for example, in the start-up heating step, optimal control of the heating amount is possible based on the precise judgment results of the quantity of rice-to-be-cooked, and rice cooking is possible with desired rice cooking characteristics such as harder and softer. Moreover, in the water absorption step, the pressure inside the pot is raised to increase the water content of rice, and, with rice cooking control suited to the above-mentioned precise judgment results of the quantity of rice-to-be-cooked, it is possible to cook tasty rice to completion.

According to the invention of claim 5, it is possible to judge precise quantity of rice-to-be-cooked by simply storing in the memory portion the pressure inside the pot in the water absorption step and the quantity-of-rice-to-be-cooked data corresponding to the pressure.

According to the invention of claim 6, by use of the pressure sensor for converting pressure into an electric signal, attachment of the pressure sensor to the lid body or the rice cooker body is easily done.

According to the invention of claim 7, in addition to the duration required for the start-up heating step, the relationship between the duration required for the start-up heating step and the duration required for the boiling keeping step is also taken into consideration such that rice is cooked with approximately equal duration with any quantity of rice-to-be-cooked. This helps reduce an uneven cooked quality due to difference in the quantity of rice-to-be-cooked inside the pot, achieving a similar cooked quality with any quantity of rice-to-be-cooked.

According to the invention of claim 8, the rice cooking steps are executed with the heating amount of the heating device controlled such that the duration required for the start-up heating step and the duration required for the boiling keeping step are substantially equal. In this case, setting a predetermined duration required for the start-up heating step to a duration for allowing rice inside the pot to absorb an adequate amount of water in the start-up heating step helps achieve a preferable value for the water content of rice that have cooked to completion with any quantity of rice-to-be-cooked. Specifically, according to the invention, it is possible to cook to completion tasty rice that gives the impression of being neither dry nor sticky.

According to the invention of claim 9, it is possible to easily raise the pressure inside the pot simply by closing the steam release hole during the water absorption step.

According to the invention of claim 10, the steam release hole is shared as part of a pressure valve, and the valve opening/closing mechanism is shared as a pressure-valve opening mechanism for forcibly placing the pressure valve into an open state. This makes it possible to perform rice cooking that achieves the above-described workings and benefits in pressure rice cookers simply by changing a control method without changing the designs of existing pressure rice cookers and without newly providing another rice cooking step etc.

According to the invention of claim 11, since the heating device is provided with the bottom heater for heating a bottom part of the pot, the side heater for heating a side part thereof, and the upper heater provided in the lid body for heating from above, the controller is capable of raising the pressure inside the pot to a predetermined value by controlling the heating amount of at least the bottom heater in the water absorption step. Moreover, by controlling the heating amounts of all the heaters, it is possible to raise the pressure inside the pot to a predetermined value more efficiently.

According to the invention of claim 12, by raising the pressure inside the container to a predetermined value in the water absorption step, rice absorbs water efficiently and the water content increases. Specifically, by raising the pressure inside the container, pressure is also applied to water and to rice, and this pressure makes water to easily pass through rice cell walls, allowing even more water to be absorbed by rice starch. Moreover, the pressure applied to rice causes a tiny crack to develop in rice. Through the crack, water permeates into the inside of rice, and passes through a gap between rice cell walls to be fed to starch in a middle part of rice, thus increasing the water content. Furthermore, variation in water absorption, i.e., so-called uneven water absorption inside the container is reduced.

The invention of claim 13 judges the quantity of rice-to-be-cooked inside the container by detecting the pressure value that has raised inside the container in the water absorption step based on the fact that the water content of rice increases when the pressure inside the container is raised in the water absorption step, and that the raised pressure value corresponds to the quantity of rice-to-be-cooked. With this rice cooking method, since the pressure value is not affected by the initial water temperature as in the conventional technology, it is possible to increase the judgment accuracy. Moreover, in the water absorption step, by raising the pressure inside the container, it is possible to increase the water content of rice.

In the invention of claim 14, the quantity-of-rice-to-be-cooked data corresponding to the pressure value is obtained previously by experiments and set, and the quantity-of-rice-to-be-cooked data is checked against the detected pressure value to thereby judge precise quantity of rice-to-be-cooked.

In the invention of claim 15, in addition to the duration required for the start-up heating step, the relationship between the duration required for the start-up heating step and the duration required for the boiling keeping step is also taken into consideration such that rice is cooked with approximately equal duration with any quantity of rice-to-be-cooked. Thus, it is possible to reduce an uneven cooked quality due to difference in the quantity of rice-to-be-cooked inside the pot, and to achieve a similar cooked quality with any quantity of rice-to-be-cooked.

### BRIEF DESCRIPTION OF DRAWINGS

FIG. 1 A front view of a pressure rice cooker according to an embodiment of the present invention.

FIG. 2 A vertical sectional view of the pressure rice cooker of FIG. 1.

FIG. 3 An enlarged view of a pressure-valve opening mechanism of FIG. 2.

FIG. 4 An enlarged view of part X of FIG. 2.

FIG. 5 A diagram of control blocks that constitute a controller.

FIG. 6 A chart diagram showing temperature and pressure variation inside a pot, a pressure valve control, heater control, etc. in rice cooking steps.

FIG. 7 Pressure curves showing the relationship between the pressure inside the pot and the quantity of rice-to-be-cooked in a water absorption step.

FIG. 8A A table showing the water content measured at predetermined places inside the pot.

FIG. 8B A table showing the relationship between the pressure value and the quantity of rice-to-be-cooked.

FIG. 9A A chart diagram showing temperature variation inside the pot in the rice cooking steps, in a case where the quantity of rice-to-be-cooked inside the pot is small.

FIG. 9B A chart diagram showing temperature variation inside the pot in the rice cooking steps, in a case where the quantity of rice-to-be-cooked inside the pot is intermediate.

FIG. 9C A chart diagram showing temperature variation inside the pot in the rice cooking steps, in a case where the quantity of rice-to-be-cooked inside the pot is large.

FIG. 10 A vertical sectional view of a conventional rice cooker.

### LIST OF REFERENCE SYMBOLS

1 (pressure) rice cooker (electric rice cooker)
2 (rice cooker) body
3 outer case
4 inner case
5 bottom heater
6 side-face heater (side heater)
7 pot-bottom-temperature sensor
8 display operation portion
9 controller
10 pot (container)
11 lid body
12 inner lid
13 pressure valve
14 ball
15 pressure-valve opening mechanism
16 fitting frame
18 inner-lid packing
19 inner-lid heater (upper heater)
20 outer lid
25 sticky-matter storing cap
26 pressure detector
27 pressure sensor

### BEST MODE FOR CARRYING OUT THE INVENTION

Hereinafter, embodiments of the present invention will be described with reference to the relevant drawings. It should be understood, however, that those embodiments described below exemplify a pressure rice cooker (hereinafter simply referred to as a “rice cooker”) as a rice cooker in which to realize the technological ideas of the invention, and that the invention is not meant to be limited to those embodiments, and other embodiments included within the scope of the claims may be equally practiced.

In this embodiment, a description will be given with a case taken up as an example where the capacity of the rice cooker is 1.0 L (5.5 go cooking) (1 go is about 0.18 liters). It should be understood, however, that the scope of application of the invention is not limited to rice cookers of this capacity. For example, the invention is applicable to rice cookers or the like of 1.8 L (1 sho cooking) capacity (1 sho is about 1.8 liters).

First, with reference to FIG. 7, a description will be given of the relationship between the pressure inside a pot and the quantity of rice-to-be-cooked in a water absorption step.

As shown in FIG. 7, the relationship between the pressure inside the pot and the quantity of rice-to-be-cooked in the water absorption step is as follows. When the quantity of rice-to-be-cooked is small, as indicated by pressure curve X1, it rises sharply in the initial stage, is at an approximately steady value at high pressure value P3, and saturates. Moreover, when the quantity of rice-to-be-cooked is large, as indicated by pressure curve X3, it rises slowly, and saturates at an approximately steady value at low pressure value P1. Furthermore, when the quantity of rice-to-be-cooked is an intermediate amount of those, pressure curve X2 thereof lies between pressure curves X1 and X3, and saturates at an approximately steady value at intermediate pressure value P2. The quantities of rice-to-be-cooked at different pressure curves X1 to X3 are as follows: 0.5 cup for curve X1, 3.3 cup for curve X2, and 5.5 cup for curve X3, where the quantity of rice-to-be-cooked is small, intermediate, and large in this order.

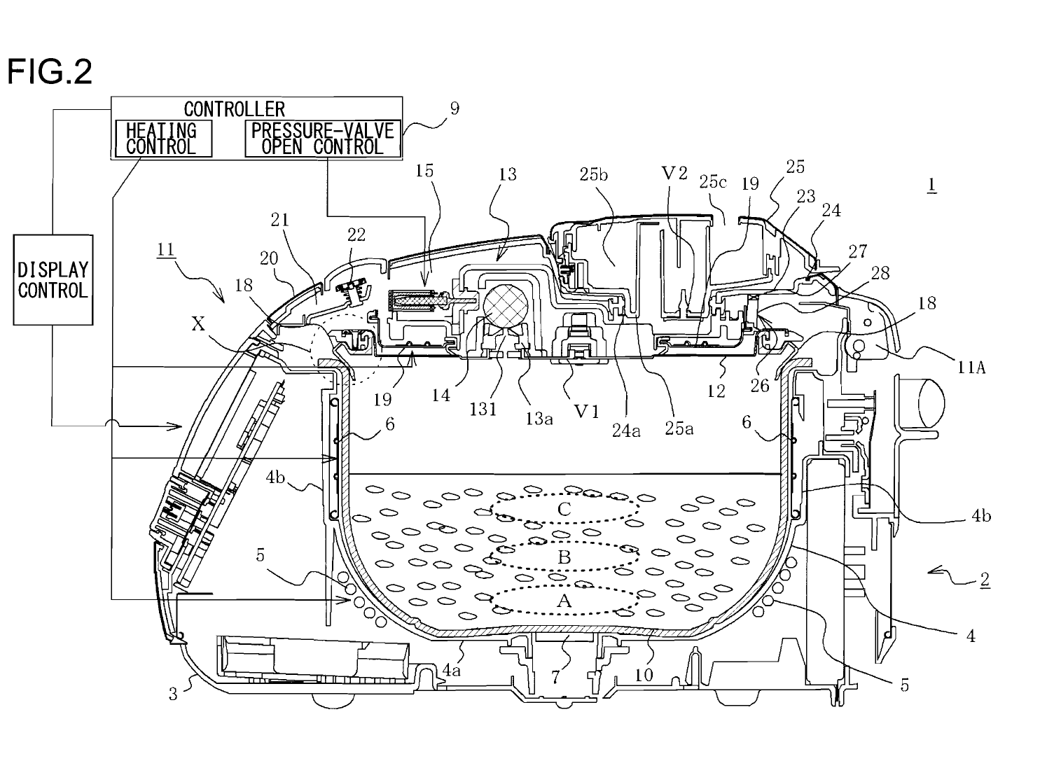

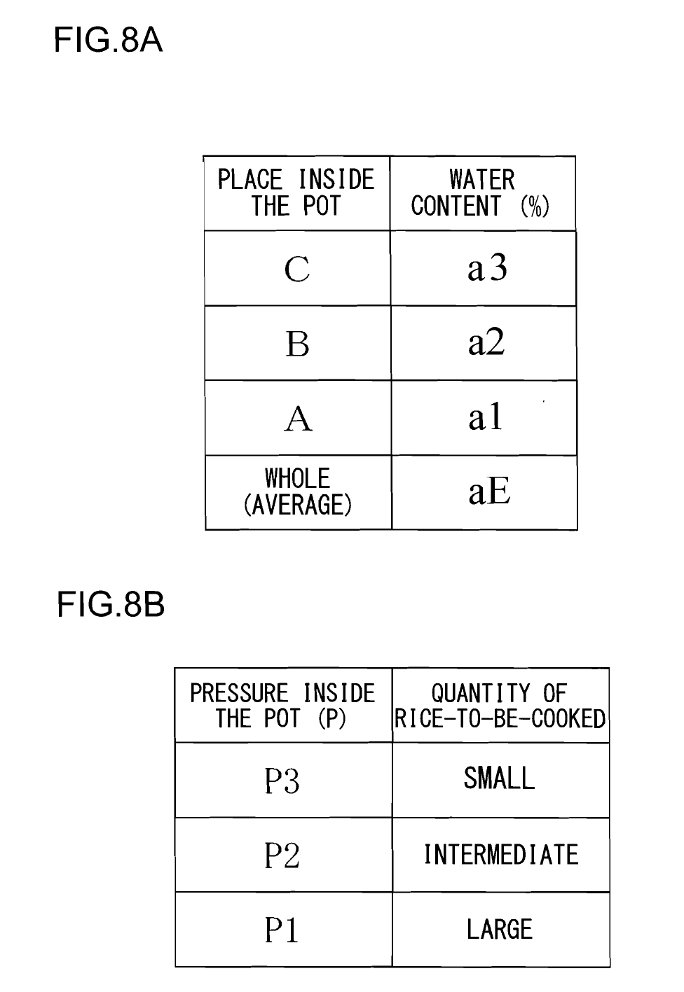

When the water content of rice was measured at a point when the pressure values become the approximately steady values (saturated) at different pressure curves X1 to X3, results shown in FIG. 8A were obtained. Specifically, with the places for measurement in a pot being bottom part A close to the bottom of the pot, middle part B located higher than bottom part A, and upper part C above middle part B (see FIG. 2); when the water content of each place was measured, bottom part A was a1, middle part B was a2, and upper part C was a3, and the average value of those was aE. The average value increases by 1.0% or more as compared with that of a case where pressure was not raised.

As a result, it is observed that the pressure values at the time of stabilization of different pressure curves X1 to X3 shown in FIG. 7 correspond one-to-one to the quantity of rice-to-be-cooked.

Thus, in this embodiment, a predetermined amount of food-substances-to-be-cooked including rice and water is accommodated in a certain container, e.g. a pot, to allow rice to absorb water, and, in this water absorption step, the pressure inside the container is raised so as to increase the water content of rice to a predetermined value and, based on the pressure value at the increased water content, the quantity of rice-to-be-cooked is judged.

Moreover, data of the quantity of rice-to-be-cooked corresponding to the pressure value is previously set, and the detected pressure value is checked against the quantity of rice-to-be-cooked data so as to judge the quantity of rice-to-be-cooked. With respect to the container, preferably, the inner part thereof is sealed against the outside, and the pressure is raised by heating. Accordingly, with the method of cooking rice, the pressure value is not affected by the initial water temperature as in the conventional technologies, thus permitting enhanced judgment accuracy. Moreover, raising the pressure inside the pot in the water absorption step permits increased water content of rice. Furthermore, with the precise judgment results, it is possible to control the heating amount of a heating device based on the quantity of rice-to-be-cooked in the following rice cooking steps, for example, in the start-up heating step, and thus it is possible to cook to completion tasty rice with desired cooking characteristics, for example, desired hardness, and the like.

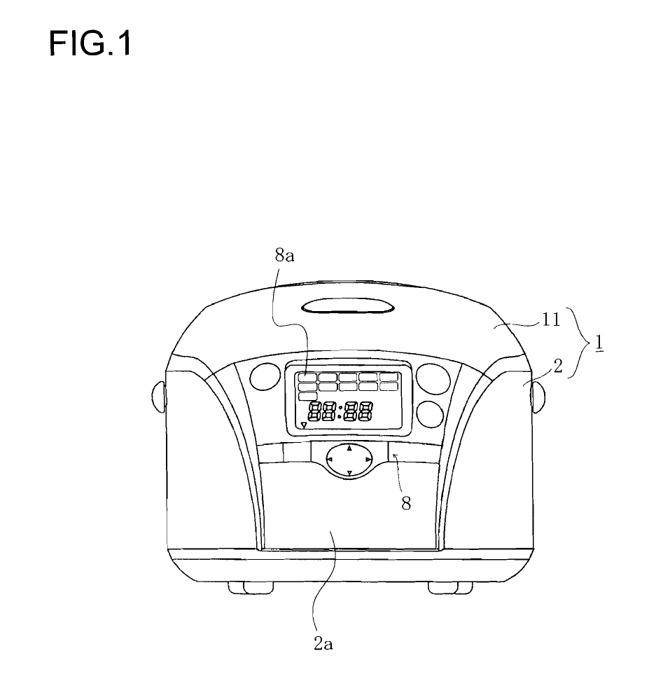

Hereinafter, with reference to FIGS. 1 to 4, a description will be given of a rice cooker provided with a quantity-of-rice-to-be-cooked judging portion according to one embodiment of the invention.

As shown in FIGS. 1 and 2, the rice cooker 1 is provided with: a pot 10 in which food-substances-to-be-cooked including rice and water are put; a rice-cooker main body (hereinafter referred to as a “main body”) 2 having, in an upper part thereof, an opening—through which the pot 10 is accommodated—and, inside it, a bottom heater 5 and a side-face heater (side heater) 6 for heating the pot 10 so as to heat the food-substances-to-be-cooked; a lid body 11 that is pivotally supported at one side of the main body 2, that covers the opening of the main body 2, and that includes a locking mechanism 21 for locking into a hermetically sealed condition; a pressure valve 13 mounted on the lid body 11 for adjusting the pressure inside the pot 10; a pressure-valve opening mechanism 15 for controlling the open/closed states of the pressure valve 13; a display operation portion 8 performing operation such as starting rice cooking, timer reservation, warming, etc.; and a controller 9 for controlling the heating device, the pressure-valve opening mechanism 15, etc. according to a start-cooking-rice signal from the display operation portion 8, the heating device including the bottom heater 5, side-face heater 6, and an inner-lid heater 19 which will be described later.

The controller 9 is provided with a memory portion. The memory portion stores rice cooking programs and warming programs for sequentially executing: a water absorption step for heating food-substances-to-be-cooked inside the pot 10 at a predetermined temperature and for allowing a predetermined amount of water to be absorbed by the food-substances-to-be-cooked over a predetermined duration; a start-up heating step for raising the temperature to heat the food-substances-to-be-cooked that have absorbed water until they boil; a boiling keeping step for keeping the food-substances-to-be-cooked in a boiling state; a steaming step for steaming the food-substances-to-be-cooked after the boiling keeping step; and a warming step for warming at a predetermined temperature the food-substances-to-be-cooked that have been cooked to completion after the steaming step; etc. Among those rice cooking steps, in the start-up heating step and the boiling keeping step, rice cooking steps are executed with the pressure inside the pot raised to, for example, about 1.1 to 2.2 atmospheres. In addition, the memory portion stores data in which the pressure value and the quantity of rice-to-be-cooked are associated.

The main body 2 is formed of an outer case 3 that has a the shape of a box with a bottom and an inner case 4 which is accommodated in the outer case 3 and has the pot 10 accommodated therein. Between the outer case 3 and the inner case 4 is formed a gap in which a control circuit board and the like of the controller 9 are arranged. The bottom heater 5 is mounted at a bottom part 4a of the inner case 4, and the side-face heater 6 is mounted at a side part 4b of the inner case 4. Used for the bottom heater 5 is an electromagnetic induction coil wound into a donut shape. Used for the side-face heater 6 is a heater having electrically-heated wires covered by a heat resistant member. Provided at the bottom part 4a is a pot-bottom-temperature sensor 7 comprising a thermistor or the like that detects the temperature at the bottom of the pot.

As shown in FIG. 1, the main body 2 is provided with a display panel 8a that displays on its front face 2a various rice cooking menus and a display operation portion 8 formed of operation buttons for selecting the rice cooking menus, etc.

As shown in FIG. 2, the pot 10 comprises a relatively deep container in which a predetermined amount of food-substances-to-be-cooked including rice and water is put. The pot 10 is formed of a cladding material of, for example, aluminum and stainless steel.

As shown in FIG. 2, the lid body 11 is composed of an inner lid 12 for closing the opening of the pot 10, an outer lid 20 for closing the whole opening of the main body 2, etc. One end of the lid body 11 is pivotally supported on one end of the main body 2 with a pivot 11A. Another end of the lid body 11 is formed so as to be locked at another end of the main body 2 by the locking mechanism 21. The lid body 11 is provided with a pressure detector 26 for detecting the pressure inside the pot 10. The pressure detector 26 includes a pressure sensor 27 for converting pressure into an electrical signal, and the pressure sensor 27 is provided in the outer lid 20 of the lid body 11.

The inner lid 12 is provided with the pressure valve 13 in an upper part thereof; the pressure-valve opening mechanism 15 that forcibly opens the pressure valve 13; a safety valve V1 for letting the steam inside the pot 10 out when the pressure inside the pot 10 increases to an abnormal pressure at or above a predetermined value; the inner-lid heater (also referred to as an “upper heater”) 19 for heating inside the pot 10 from above; etc.

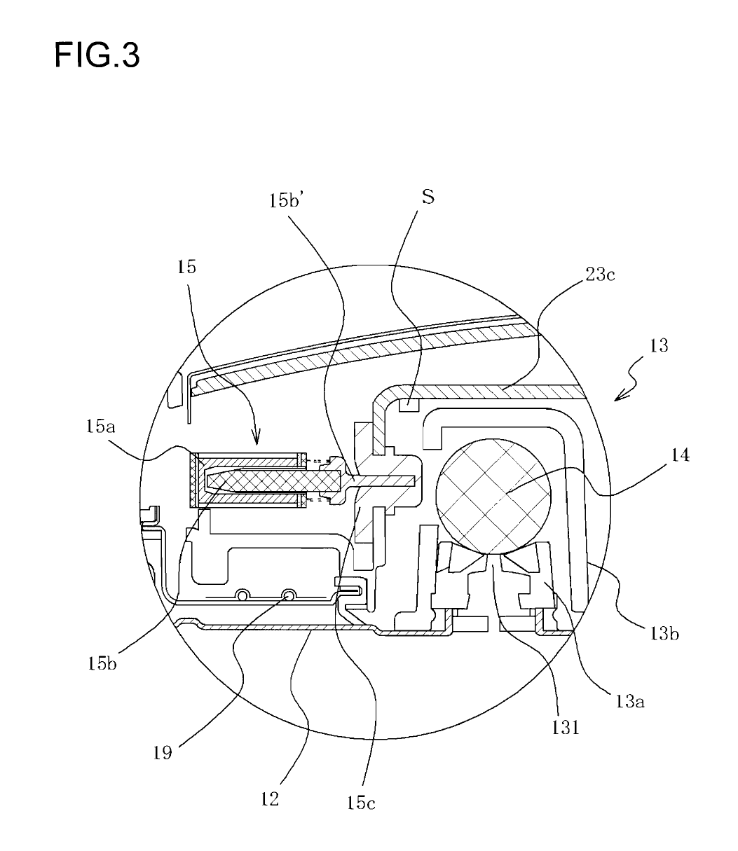

Of those components, for the inner-lid heater 19, a heater having electrically-heated wires covered with a heat resistant member are used, like the side-face heater 6. As shown in FIGS. 2 and 3, the pressure valve 13 is composed of a valve seat 13a having a valve hole 131 with a predetermined diameter formed therein, a ball 14 formed of metal that is placed on the valve seat 13a so as to cover the valve hole 131, and a cover 13b for restricting movement of the ball 14 so as to keep it on the valve seat 13a. The ball 14 has a predetermined weight and, by its own weight, closes the valve hole 131.

As shown in FIG. 3, the pressure-valve opening mechanism 15 is composed of a cylinder 15a on which an electromagnetic coil is wound; a plunger 15b that slides in the cylinder 15a due to excitation of the electromagnetic coil to move the ball 14; and a spring and an operative pole 15b′ that are mounted on the tip of the plunger 15b. The operative pole 15b′ is supported by a sealing member 15c having elasticity. FIG. 3 shows a state in which the electromagnetic coil is excited.

The pressure-valve opening mechanism 15 is controlled by the controller 9. When the electromagnetic coil is excited based on a command from the controller 9, the plunger 15b is pulled into the cylinder 15a. This removes the force of the plunger 15b that presses the ball 14 sideways, and thus the ball 14 is placed on the valve seat 13a by its own weight, and the valve hole 131 is closed by the ball 14. On the other hand, when the excitation with respect to the electromagnetic coil is stopped, the plunger 15b projects through the cylinder 15a due to the force of the spring. This makes the operative pole 15b′ mounted on the tip of the plunger 15b to hit the ball 14, and the ball 14 is pushed out sideways. Due to this pushing, the ball 14 is moved off from the valve seat 13a, and the valve hole 131 is opened. In an upper part of the pressure valve 13, a steam temperature sensor S that measures the temperature of the steam jetting out through the valve hole 131 is attached.

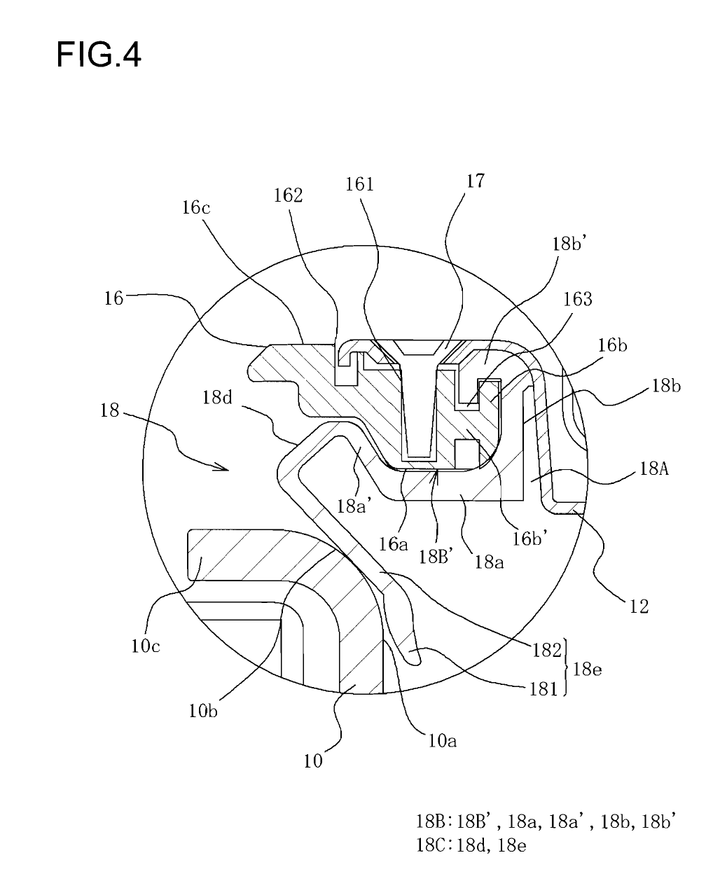

At the outer periphery of the inner lid 12, inner-lid packing 18 is attached that makes contact with the opening of the pot 10 to hermetically seal it. As one end part thereof is shown in FIG. 4, the inner-lid packing 18 includes inside it: a circular hole 18A having a diameter slightly smaller than that of the disc-like inner lid 12; a fitting part 18B for fitting to the outer peripheral edge of the inner lid 12 with a ring-shaped fitting frame 16 laid in between; and a sealing portion 18C that makes contact with the opening of the pot 10 to hermetically seal the opening. The inner-lid packing 18 is formed to be a ring of which the entire part is donut like, and is formed of a silicon material having high heat-resistant properties and elasticity.

The fitting part 18B includes a concave groove 18B′ to which the fitting frame 16 having a ring shape is fitted, and is formed at the outer circumference of the circular hole 18A. The concave groove 18B′ is formed of a groove bottom 18a that has a substantially flat annular shape and is provided to extend outward from the circular hole 18A; a cylindrical wall 18b provided to stand substantially at a right angle from an edge, on the circular hole 18A side, of the groove bottom 18a; and an extended portion 18a′ extended from the groove bottom 18a. In the cylindrical wall 18b, there is formed a locking claw 18b′ having a hook shape that projects outward from a top part of the cylindrical wall 18b with the tip of the hook bent downward.

The sealing portion 18C is provided to extend further from the extended portion 18a′ of the groove bottom 18a, and is formed into a substantially U shape. The U-shaped sealing portion 18C is formed of a spring piece 18d that extends from the extended portion 18a′ so as to correspond to the U-shaped bottom, and an elastic sealing portion 18e that extends from the spring piece 18d. The elastic sealing portion 18e includes a tip contact portion 181 for making contact with an inner wall 10a of the pot 10, and an intermediate contact portion 182 for making contact with a curved portion 10b between the inner wall 10a and a pot flange 10c.

The fitting frame 16 includes: a bottom portion 16a fitted into the concave groove 18B′ and making contact with a groove-bottom-18a face; a body portion 16b that extends upward from the bottom portion 16a; and a top portion 16c that is flat and is provided above the body portion 16b. The fitting frame 16 comprises a ring frame having a donut shape as a whole, and is formed of a resin component having high heat-resistant properties and a predetermined mechanical strength. In the fitting frame 16, in the flat face of the top portion 16c, an internal threaded hole 161 is cut that extends down from the flat face toward the bottom portion 16a. In addition, in the flat face of the top portion 16c, a locking groove 162 is formed. Furthermore, in a side face of the body portion 16b—specifically the side face on a cylindrical-wall-18b-face side—, an H-shaped engaging portion 16b′ having a locking groove 163 is formed. The locking claw 18b′ provided at the top of the cylindrical wall 18b is locked into the locking groove 163 of the H-shaped engaging portion 16b′.

To attach the inner-lid packing 18 to the inner lid 12, first, the ring-shaped fitting frame 16 is fitted to the inner-lid packing 18. In this fitting, the ring-shaped fitting frame 16 is placed on top of the cylindrical wall 18b of the inner-lid packing 18, and then the fitting frame 16 is pressed downward. With this pressing, the cylindrical wall 18b flexes inwardly due to its elasticity, and the fitting frame 16 is allowed to be inserted downward. When the bottom portion 16a of the fitting frame 16 is pressed to a position where it touches a bottom face of the concave groove 18B′, the cylindrical wall 18b is restored to its original position due to the restoring force, and with this timing, the locking claw 18b′ at the top of the cylindrical wall 18b is locked into the engagement groove 163 of the H-shaped engaging portion 16b′. With this engagement, the inner-lid packing 18 is fixed to the fitting frame 16. Thereafter, the fitting frame 16 to which the inner-lid packing 18 is fixed is made to make contact with the outer peripheral edge of the inner lid 12, and an external screw 17 is screwed into the internal threaded hole 161 provided at the outer peripheral edge for fixation.

Since the inner-lid packing 18 includes the U-shaped sealing portion 18C formed of the spring piece 18d that corresponds to the U-shaped bottom portion and the elastic sealing portion 18e that extends from the spring piece portion 18d, when the opening of the main body 2 is closed by the lid body 11, the elastic sealing portion 18e of the sealing portion 18C acts against the spring force of the spring piece 18d and makes close contact with the inner wall face 10a of the pot 10 and the curved portion 10b, ensuring air tightness. Accordingly, almost no steam leakage occurs from inside the pot 10, making it possible to suppress loss of heat energy to a minimum and hence save energy. Moreover, since the inner-lid packing 18 is fixed to the inner lid 12 with the fitting frame 16 laid in between, fitting is achieved with the inner-lid packing 18 with elasticity being supported with the fitting frame 16 with strong mechanical strength, allowing the inner-lid packing 18 to be fixed firmly. Furthermore, since the fitting frame 16 and the inner-lid packing 18 are attachable and detachable without using a tool, replacement of an old inner-lid packing 18 is easy.

As shown in FIG. 2, the outer lid 20 is formed of a decorative cover covering the inner lid 12, the pressure valve 13 mounted in the inner lid 12, the pressure-valve opening mechanism 15, etc. The outer lid 20 is provided with, at one end part, a release button 22 for releasing the locking mechanism 21 of the lid body 11 and, at the other end part on the pivot 11A side, a fitting recess 24. The fitting recess 24 comprises a recessed hole—with a bottom—which is so sized that a sticky-matter storing cap 25 is insertable in a freely attachable/detachable manner. In addition, the fitting recess 24 is formed in a frame 23 that supports the outer lid 20. At the bottom of the fitting recess 24, a fitting hole 24a is formed into which a discharge tube 25a of the sticky-matter storing cap 25 is press-fitted. An annular sealing member is fitted to an internal part of the fitting hole 24a so that the internal part is pressed against the outer surface of the discharge tube 25a to prevent steam inside the pot 10 from leaking out.

The sticky-matter storing cap 25 includes: the discharge tube 25a for discharging, for example, steam that is exhausted through the pressure valve 13, and the like; an empty chamber 25b for storing sticky matter, i.e., tasty components; and a steam release port 25c that releases steam to the outside. At the bottom of the empty chamber 25b, a tasty-matter return valve V2 for returning the stored tasty matter into the pot 10 is provided. When steam jets out via the pressure valve 13, together with the steam, the sticky matter—the tasty components—is led out from the pot 10 via the pressure valve 13 to be stored in the empty chamber 25b of the sticky-matter storing cap 25. As the sticky-matter return valve V2 is opened with predetermined timing, the sticky matter stored in the empty chamber 25b is returned into the pot 10 in accordance with the opening of a negative pressure valve (unillustrated) provided in the inner lid 12.

The pressure detector 26 includes a detection hole (unillustrated) provided in the inner lid 12, and the pressure sensor 27 provided to correspond to the detection hole. So that steam etc. generated inside the pot 10 is prevented from leaking to the outside, the detection hole and the pressure sensor 27 are pressed to make elastic contact with a tubular member 28 having elasticity. Specifically, when the inner lid 12 is fitted to the outer lid 20, the tubular member 28 connects the detection hole and the pressure sensor 27 by elastic contact so as to prevent leakage of steam etc. It should be noted that the pressure detector is not limited to one described above; pressure may be detected based on the shifted amount of the inner lid 12, i.e., the amount the inner lid 12 is shifted when it is lifted due to pressure increase inside the pot 10, or may be detected by any other methods.

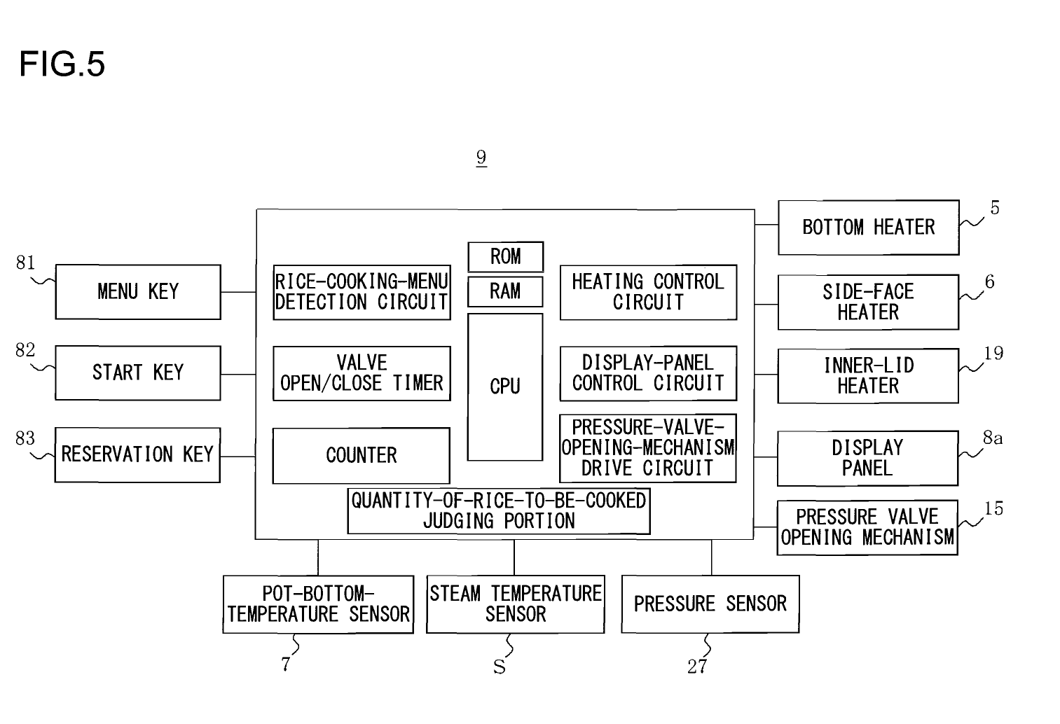

Next, with reference to FIG. 5, the configuration of the controller 9 will be described.

The controller 9 includes: a CPU for performing various kinds of computation; a memory portion formed of a ROM and a RAM that store various kinds of data; a rice-cooking-menu detection circuit for detecting a selected rice cooking menu; a quantity-of-rice-to-be-cooked judging portion; a valve open/close timer in which the duration of opening/closing of the pressure valve 13 is set; a counter for counting the number of times the pressure valve 13 is opened/closed; a heating control circuit for controlling the temperature and duration of heating inside the pot 10; a display-panel control circuit for controlling a display screen displayed on the display panel 8a; a pressure-valve-opening-mechanism drive circuit for controlling opening/closing timing of the pressure valve 13 by driving the pressure-valve opening mechanism 15; etc.

In the memory portion, rice cooking programs corresponding to various rice cooking menus are stored. The rice cooking programs are, as described above, a water absorption step, a start-up heating step, a boiling keeping step, a steaming step, a re-cooking step, and a warming step after completion of those cooking steps. The memory portion stores data in which the pressure value and the quantity of rice-to-be-cooked are associated. As shown in FIG. 8B, in the data, with respect to pressures P1, P2, and P3, the quantity of rice-to-be-cooked is large, intermediate, and small. Needless to say, the data may be such that pressures P1, P2, and P3 are subdivided, and the quantity of rice-to-be-cooked are subdivided to correspond to those pressures. The relationship between the pressure value and the quantity of rice-to-be-cooked is obtained from experiments.

Various commands are fed to the controller 9 via a menu key 81, a start key 82, a reservation key 83, and another key on the display operation portion 8. Likewise, from the pot-bottom-temperature sensor 7, the steam temperature sensor S, the pressure sensor 27, and another sensor, corresponding detected values are fed to the controller 9. Connected to the controller 9 are the bottom heater 5, the side-face heater 6, the inner-lid heater 19, the display panel 8a, the pressure-valve opening mechanism 15, etc.

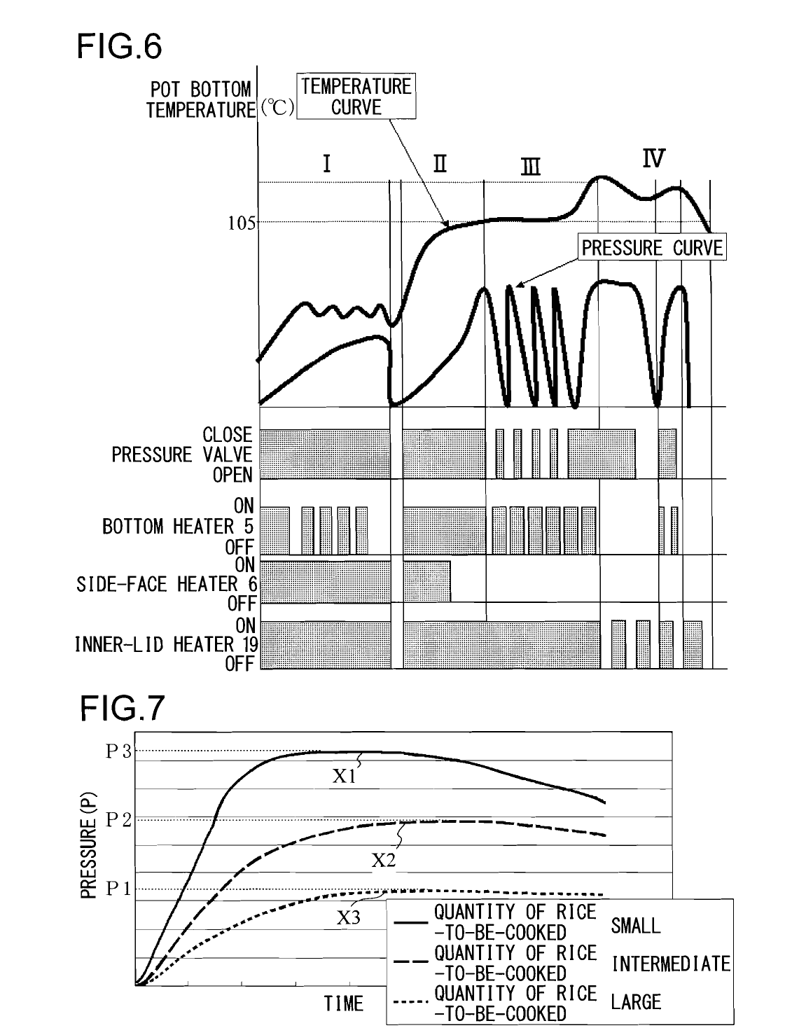

With reference mainly to FIGS. 5 to 8A, judgment of the quantity of rice-to-be-cooked and rice cooking steps will be described.

First, a predetermined menu is selected from rice cooking menus displayed on the display panel 8a and the display operation portion 8 is operated, whereupon the controller 9 follows the selected rice cooking program, and controls the bottom heater 5, the side-face heater 6, the inner-lid heater 19, and the pressure-valve opening mechanism 15 to execute water absorption step I for heating food-substances-to-be-cooked inside the pot 10 to a predetermined temperature and allowing the food-substances-to-be-cooked to absorb a predetermined amount of water at a predetermined temperature over a predetermined duration; start-up heating step II for raising the temperature to heat the food-substances-to-be-cooked that has absorbed water until they boil; boiling keeping step III for keeping the food-substances-to-be-cooked in a boiling state; and steaming step IV for steaming the food-substances-to-be-cooked after boiling keeping step III.

In water absorption step I, the controller 9 closes the pressure valve 13 and, in this state, controls the heating amounts of the bottom heater 5, the side-face heater 6, and the inner-lid heater 19 so as to allow rice to absorb water with the temperature inside the pot 10 set at a predetermined water absorption temperature, for example, at 60° C. When heating is performed with the pressure valve 13 closed, as shown in FIG. 7, pressure P inside the pot 10 increases along a pressure curve corresponding to a quantity of rice-to-be-cooked. It has been observed that, as the pressure inside the pot 10 increases, the water content of rice increases. Specifically, with those places inside the pot 10 for measurement being bottom part A close to the bottom of the pot, middle part B located higher than the bottom part, and upper part C located higher than the middle part, when the water contents of those places are measured, as shown in FIG. 8A, bottom part A is a1, middle part B is a2, and upper part C is a3, and the average value is aE. The average value increases by 1.0% or more as compared with that of a case where pressure is not raised.

Accordingly, in water absorption step I, since water is absorbed by rice with the temperature inside the pot 10 raised to a predetermined temperature and with the internal pressure of the pot 10 increased, it is possible to allow sufficient water to be absorbed by rice effectively and efficiently with no uneven water absorption. Specifically, raising the pressure inside the pot 10 applies pressure to water and to rice, and this pressure makes it easier for water to pass through rice cell walls, allowing even more water to be absorbed by rice starch. Furthermore, the pressure applied to rice causes a tiny crack to develop in the rice. Through the crack, water permeates into the rice, passes through a gap between the rice cell walls, and is fed to starch in a center part of the rice, thus increasing the water content. In this water absorption step I, the relationship between pressure value P inside the pot 10 and the quantity of rice-to-be-cooked was obtained from experiments. As a result, the relationship is as shown in FIG. 7. As indicated by pressure curve X1, when the quantity of rice-to-be-cooked is small, it rises sharply in the initial stage, is at an approximately steady value at high pressure value P3 and saturates. In addition, as indicated by pressure curve X3, when the quantity of rice-to-be-cooked is large, it rises slowly and saturates at an approximately steady value at low pressure value P1. Further, when the quantity of rice-to-be-cooked is an intermediate quantity between the large amount and the small amount, pressure curve X2 lies between different pressure curves X1 and X3 and, at intermediate pressure value P2, the value saturates at approximately steady value. Pressure value P is within the range of 1.05 to 1.18 atmospheres. The quantities of rice-to-be-cooked at different pressure curves X1 to X3 are as follows: 0.5 cup for curve X1, 3.3 cup for curve X2, and 5.5 cup for curve X3, where the quantities of rice-to-be-cooked are small, intermediate, and large in this order. Then, when the water content of rice is measured at a point when the pressure value become an approximately steady value (saturate) at different pressure curves X1 to X3, the results of FIG. 8A are obtained. A value aE having those water contents a1 to a3 averaged increases by 1.0% or more as compared with that in a case where pressure is not raised. The relationship between the water contents and the quantities of rice-to-be-cooked is such that the water content is high when the quantity of rice-to-be-cooked is small, and that the water content decreases as the quantity of rice-to-be-cooked increases. However, by application of pressure, those water contents increase as compared with a case without application of pressure. The relationship between the pressure inside the pot 10 and the quantity of rice-to-be-cooked is previously stored in the memory portion.

Pressure value P is detected by the pressure sensor 27. The detected value is fed to the quantity-of-rice-to-be-cooked judging portion, is checked against quantity-of-rice-to-be-cooked data stored in the memory portion, and the quantity of rice-to-be-cooked is judged.

Accordingly, the pressure values at points at which different pressure curves X1 to X3, shown in FIG. 7, become stable correspond one-to-one to the quantity of rice-to-be-cooked. Thus, by detecting those pressure values, it is possible to simply and precisely judge the quantity of rice-to-be-cooked. Moreover, the judgment of the quantity of rice-to-be-cooked is not affected by the initial water temperature and hence is precise.

In the following start-up heating step II, the heating amount of the heating device is controlled based on the quantity of rice-to-be-cooked. In this step, the pressure inside the pot 10 is raised to, for example, 1.2 atmospheres.

In start-up heating step II, since precise judgment of quantity of rice-to-be-cooked is performed in water absorption step I, heating is performed with a proper electrical energy based on the precise quantity of rice-to-be-cooked from the initial stage of start-up heating step II. Accordingly, by precise judgment of the quantity of rice-to-be-cooked, it is possible to freely set the degree of temperature increase in start-up heating step II, and thus it is easy to distinguish cooking levels such as hard and soft. Accordingly, tasty rice is cooked to completion with desired rice cooking characteristics, for example, desired hardness, and the like.

In boiling keeping step III, the pressure valve 13 is forcibly opened one or more times to allow the pressure inside the pot 10 during boiling to immediately decrease so as to be around atmospheric pressure. Due to the opening of the pressure valve 13, a bumping phenomenon occurs inside the pot 10, and rice is vigorously agitated. In addition, due to the opening of the pressure valve 13, sticky matter of tasty components produced inside the pot 10 passes via the pressure valve 13 to be temporarily stored in the sticky-matter storing cap 25. The sticky matter stored in the storing cap 25 is returned into the pot 10 when the sticky-matter return valve V2 opens with predetermined timing.

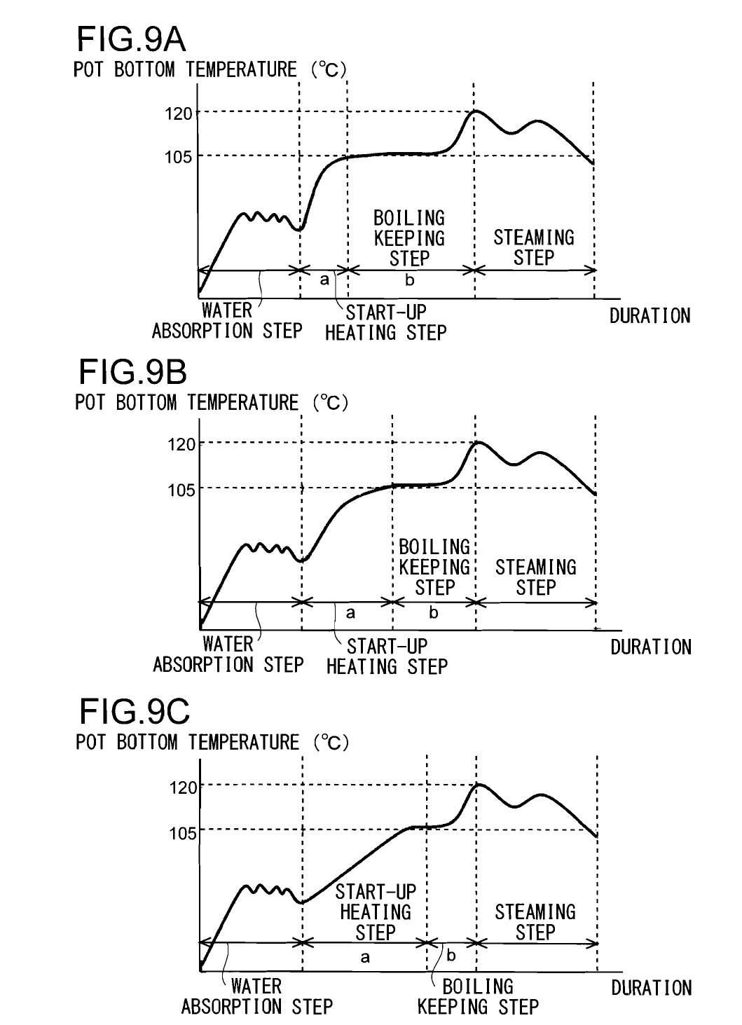

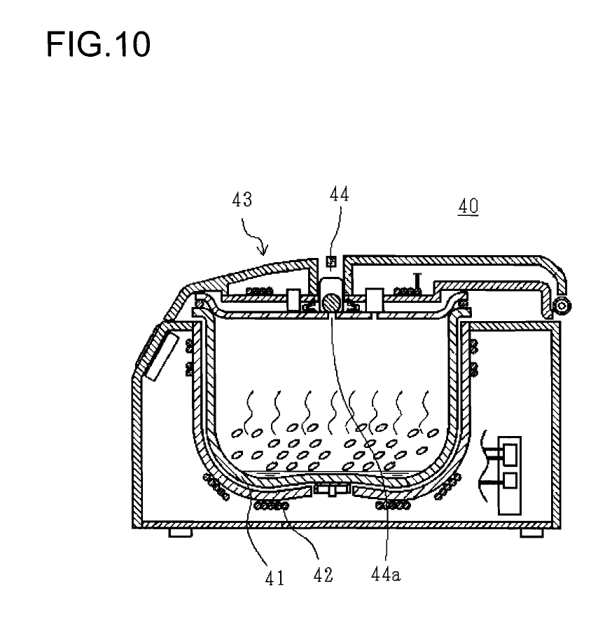

Now, a description will be given of an example of a method of heating control by the controller 9 in start-up heating step II and boiling keeping step III. In the description, FIGS. 9A to 9C will be referred to as necessary.

FIGS. 9A to 9C are diagrams showing the relationship between duration and temperature (temperature at the bottom of the pot) in rice cooking steps. FIG. 9A shows a case where the quantity of rice-to-be-cooked is small, FIG. 9B shows a case where the quantity of rice-to-be-cooked is intermediate, and FIG. 9C shows a case where the quantity of rice-to-be-cooked is large. It is assumed here that, when the quantity of rice-to-be-cooked—as food-substances-to-be-cooked—is 0.5 cup (0.5 go), the quantity of rice-to-be-cooked is small; when the quantity of rice-to-be-cooked is 3.3 cup (3.3 go), the quantity of rice-to-be-cooked is intermediate; and when the quantity of rice-to-be-cooked is 5.5 cup (5.5 go), the quantity of rice-to-be-cooked is large. FIGS. 9A to 9C show cases where electrical energy (start-up heating electrical energy) applied to a heating device during start-up heating step II is a fixed electrical energy regardless of the quantity of rice-to-be-cooked, and furthermore, electrical energy (boiling keeping electrical energy) applied to the heating device during boiling keeping step III is a fixed electrical energy regardless of the quantity of rice-to-be-cooked. Note that the start-up heating electrical energy and the boiling keeping electrical energy are electrical energies of different magnitudes.

In start-up heating step II, since heating is performed at a fixed electric energy regardless of the quantity of rice-to-be-cooked, as shown in FIGS. 9A to 9C, the duration required for reaching a boiling state is short in a case where the quantity of rice-to-be-cooked is small, and the duration required for reaching a boiling state is long in a case where the quantity of rice-to-be-cooked is large. Judgment of whether or not the boiling state is reached is possible by the temperature measured by the steam temperature sensor S (see FIGS. 3 and 5); for example, the boiling state may be judged to have reached at a point when the temperature measured by the steam temperature sensor S becomes 74° C. In addition, at the point where the temperature measured by the steam temperature sensor S becomes 74° C., start-up heating step II is switched to boiling keeping step III.

When the duration required for start-up heating step II is short as in the case of FIG. 9A, boiling keeping step III is performed before water is sufficiently absorbed by rice. In this case, the amount of water becomes relatively large at a point when boiling keeping step III is started, and the duration required for boiling keeping step III is longer. Besides, in the case of FIG. 9A, as compared with duration “a” required for start-up heating step II, duration “b” required for boiling keeping step III is longer (a<b). Judgment of the completion of boiling keeping step III is done by the temperature measured by the pot-bottom-temperature sensor 7 (see FIGS. 2 and 5). For example, at a point when the temperature measured by the pot-bottom-temperature sensor 7 reaches 120° C., water inside the pot 10 dries up and forced drying up is judged to have completed. Thus, boiling keeping step III is completed at that temperature to proceed to steaming step IV.

In the case of FIG. 9A, when the water content of rice inside the pot 10 after completion of the rice cooking steps was studied, the average value was about 64%, and the rice gave the impression of being sticky.

On the other hand, when the duration required for start-up heating step II is long as in the case of FIG. 9C, the amount of water absorbed by rice increases. In this case, the amount of water is relatively small at a point when boiling keeping step III has started, and the duration required for boiling keeping step III is short. Besides, in the case shown in FIG. 9C, as compared with duration “a” required for start-up heating step II, duration “b” required for boiling keeping step III is short (a>b).

In the case of FIG. 9C, when the water content of rice inside the pot 10 after completion of rice cooking steps was studied, the average value was about 62%. However, with respect to the water content of rice that have been cooked to completion, a large difference was observed between the water contents of rice in a surface part of food-substances-to-be-cooked and rice in a peripheral part of the pot 10 and the water content of rice in a middle part of the pot 10. With respect to the condition of the rice that have been cooked to completion, the rice in the surface part of the food-substances-to-be-cooked and the rice in the peripheral part of the pot 10 gave the impression of being sticky, and the rice in the middle part of the pot 10 gave the impression of being dry.

As in FIG. 9B, in the case where the quantity of rice-to-be-cooked is intermediate, duration “a” required for start-up heating step II is a duration in between the case where the quantity of rice-to-be-cooked is small and the case where the quantity of rice-to-be-cooked is large. In addition, in the case shown in FIG. 9B, duration “a” required for start-up heating step II and duration “b” required for boiling keeping step III are almost equal (a=b). In the case of FIG. 9B, when the water content of rice inside the pot 10 after completion of the rice cooking steps was studied, the average value was about 62.5%, and the rice gave the impression of being neither sticky nor dry, and were tastily cooked to completion, which was ideal.

As described above, when the same rice cooking method is used even with different quantity of rice-to-be-cooked, a difference may occur in cooked quality depending on the quantity of rice-to-be-cooked, preventing achieving a tasty cooked quality. Thus, based on the above results, various studies have been conducted on preferred heating control of the rice cooker 1, and the following have been found.

First, in order to reduce unevenness in the cooked quality due to the difference in the quantity of rice-to-be-cooked, with any quantity of rice-to-be-cooked, it is found that, preferably, the total duration spent for start-up heating step II and boiling keeping step III is approximately equal. Besides, with any quantity of rice-to-be-cooked, it has been found that, preferably, the rice cooking steps are executed such that duration “a” required for start-up heating step II and duration “b” required for boiling keeping step III are in a constant relationship, in order to reduce unevenness in the cooked quality (in other words, with any quantity of rice-to-be-cooked, the ratio of duration “a” to duration “b” is approximately equal).

Moreover, it has been found that, in order to achieve an equivalent tasty cooked quality with any quantity-of-rice-to-be-cooked, reaching a boiling state immediately or slowly in start-up heating step II is undesirable with any quantity-of-rice-to-be-cooked. A preferable duration for start-up heating step II is such a duration that permits rice to adequately absorb water. This has been found to be the same with any quantity of rice-to-be-cooked. The duration is obtained from, for example, experiments. Furthermore, with any quantity of rice-to-be-cooked, it has been found that, preferably, duration “a” required for start-up heating step, which is previously determined as a duration for permitting water to be adequately absorbed, and duration “b” required for boiling keeping step III are approximately equal.

Thus, in this embodiment, a duration (a predetermined duration) that allows rice to adequately absorb water in start-up heating step II is obtained, and that duration serves as the duration required for start-up heating step II. The predetermined duration is the same duration with any quantity of rice-to-be-cooked, and is a fixed value. Besides, with any quantity of rice-to-be-cooked, the rice cooking steps are executed while the heating amount of heating device is controlled such that the predetermined duration previously obtained is duration “a” required for start-up heating step II, and duration “b” required for boiling keeping step III is approximately equal to duration “a” required for start-up heating step II.

For example, a temperature variation pattern as shown in FIG. 9B is an ideal temperature variation, and in the rice cooker 1, the controller 9 controls the heating amount applied to food-substances-to-be-cooked inside the pot 10 by the heating device (the bottom heater 5, the side-face heater 6, and the inner-lid heater 19) such that, with any quantity of rice-to-be-cooked, a temperature variation pattern as shown in FIG. 9B is achieved. This helps achieve a tasty cooked quality with a similar taste with any quantity of rice-to-be-cooked. According to the method of cooking rice of this embodiment, the water content of rice that have been cooked to completion is at an average value of about 62.5% with any quantity of rice-to-be-cooked, suppressing variation in the water content of rice inside the pot 10.

On completion of the rice cooking steps as described above, a warming step is performed automatically or by a command from the display operation portion 8. In the warming step, the controller 9 warms inside the pot 10 for a predetermined duration and at a predetermined temperature. In this period of time, the controller 9 intermittently turns on and off the bottom heater 5, the side-face heater 6, and the inner-lid heater 19 respectively to control warming at a predetermined warming temperature, for example, at 70° C. or above. With this warming control, condensation on the inner wall of the pot 10 is reduced so as to allow warming at an optimal temperature.

In the above description, although a pressure rice cooker according to one embodiment of the present invention is dealt with, the invention is not limited to the pressure rice cooker; the invention is applicable to ordinary non-pressure rice cookers. The non-pressure rice cookers are provided with a steam release hole for releasing steam inside a pot to the outside, and thus, by providing in the steam release hole an opening/closing mechanism that opens and closes the steam release hole, it is possible to design a rice cooker that enjoys workings and benefits described above.

1. An electric rice cooker comprising:
a pot for accommodating food-substances-to-be-cooked including water and rice;
a heating device for heating food-substances-to-be-cooked inside the pot;
a lid body for closing an opening of the pot; and
a controller for executing rice cooking steps including a water absorption step for allowing rice to absorb water by controlling the heating device,
wherein the controller raises pressure inside the pot to a predetermined value in the water absorption step to allow rice to absorb water.

2. The electric rice cooker according to claim 1,
wherein the controller raises and controls pressure inside the pot to be within a range from 1.05 to 1.18 atmospheres in the water absorption step.

3. The electric rice cooker according to claim 1,
wherein pressure inside the pot is changed according to quantity of rice-to-be-cooked inside the pot.

4. The electric rice cooker according to claim 1, further comprising:
a pressure detector for detecting pressure inside the pot; and
a quantity-of-rice-to-be-cooked judging portion for receiving a detected value of the pressure detector and judging quantity of rice-to-be-cooked inside the pot,
wherein
in the water absorption step, after the pot is hermetically sealed,
the controller
raises temperature inside the pot to a predetermined temperature by the heating device,
detects a pressure value inside the pot by the pressure detector, and
feeds the detected value to the quantity-of-rice-to-be-cooked judging portion to judge quantity of rice-to-be-cooked inside the pot.

5. The electric rice cooker according to claim 4,
wherein the controller includes a memory portion,
wherein the memory portion stores a target pressure inside the pot in the water absorption step and quantity-of-rice-to-be-cooked data corresponding to the target pressure, and
wherein the quantity-of-rice-to-be-cooked judging portion checks the detected value detected by the pressure detector against quantity-of-rice-to-be-cooked data stored in the memory portion to judge quantity of rice-to-be-cooked inside the pot.

6. The electric rice cooker according to claim 4, further comprising a rice cooker body in which the pot is placed and the heating device is provided,
wherein the pressure detector includes a pressure sensor for converting pressure into an electrical signal, and
wherein the pressure sensor is provided in the lid body or in the rice cooker body.

7. The electric rice cooker according to claim 4,
wherein the rice cooking steps further include:
a start-up heating step for raising temperature to heat food-substances-to-be-cooked that have absorbed water in the water absorption step until the food-substances-to-be-cooked boil; and
a boiling keeping step for keeping food-substances-to-be-cooked in a boiling state, and
wherein the controller controls a heating amount of the heating device according to quantity of rice-to-be-cooked inside the pot such that a first duration required for the start-up heating step is a predetermined duration, and that the first duration is in a constant relationship with a second duration required for the boiling keeping step, with any quantity of rice-to-be-cooked inside the pot.

8. The electric rice cooker according to claim 7,
wherein the constant relationship is a relationship such that the first duration and the second duration are substantially equal.

9. The electric rice cooker according to claim 1,
wherein the lid body is provided with a steam release hole for releasing steam inside the pot to outside, and a valve opening/closing mechanism for closing or opening the steam release hole, and
wherein, in the water absorption step, the controller operates the heating device and closes the steam release hole by the valve opening/closing mechanism to raise pressure inside the pot.

10. The electric rice cooker according to claim 9,
wherein the steam release hole is shared as part of a pressure valve,
wherein the valve opening/closing mechanism is shared as a pressure-valve opening mechanism for forcibly placing the pressure valve into an open state, and
wherein the controller performs rice cooking control with pressure inside the pot raised to or above atmospheric pressure in a boiling keeping step of the rice cooking steps.

11. The electric rice cooker according to claim 1,
wherein the heating device includes a bottom heater for heating a bottom part of the pot, a side heater for heating a side part thereof, and an upper heater provided in the lid body for heating from above, and
wherein the controller controls a heating amount of at least the bottom heater in the water absorption step.

12. A method of cooking rice comprising rice cooking steps including a water absorption step in which a predetermined amount of food-substances-to-be-cooked including rice and water is accommodated in a container for allowing rice to absorb water, and
wherein internal pressure of the container is raised to a predetermined value in the water absorption step to allow rice to absorb water.

13. The method of cooking rice according to claim 12,
wherein, in the water absorption step, after the container is hermetically sealed, temperature inside the container is raised to a predetermined temperature, whereupon pressure inside the container is detected, and, based on the detected value, quantity of rice-to-be-cooked inside the container is judged.

14. The method of cooking rice according to claim 13,
wherein quantity-of-rice-to-be-cooked data corresponding to a pressure value inside the container is previously set, and
wherein, with the detected pressure value checked against the quantity-of-rice-to-be-cooked data, quantity of rice-to-be-cooked is judged.

15. The method of cooking rice according to claim 13,
wherein the rice cooking steps further include:
a start-up heating step for raising temperature to heat food-substances-to-be-cooked that have absorbed water in the water absorption step until the food-substances-to-be-cooked boil; and
a boiling keeping step for keeping food-substances-to-be-cooked in a boiling state, and
wherein rice cooking is performed while a heating amount is controlled according to quantity of rice-to-be-cooked inside the pot such that a first duration required for the start-up heating step is a predetermined duration, and that the first duration is in a constant relationship with a second duration required for the boiling keeping step, with any quantity of rice-to-be-cooked inside the container.
